(19) United States
(12) Patent Application Publication
(10) Pub. No.: US 2014/0189884 A1
(43) Pub. Date: Jul. 3, 2014

(54) Lengthy Hosting Internet System

(71) Applicant: Weird Apparatus Pty Ltd, Vaucluse (AU)

(72) Inventor: Anton Madievski, Vaucluse (AU)

(73) Assignee: WEIRD APPARATUS PTY LTD, Vaucluse (AU)

(21) Appl. No.: 14/174,853

(22) Filed: Feb. 7, 2014

(30) Foreign Application Priority Data
Jan. 5, 2011 (AU) 2011100022

(51) Int. Cl. G06F 21/62

(52) U.S. Cl. CPC G06F 21/62
USPC 726/27

(57) ABSTRACT

The disclosed internet/web/cloud/online hosting system is a system hosting internet sites for extended periods of time or indefinitely, thus the site surviving its creator. There may be provided a guarantee of the period of hosting. The guarantee may be based on an insurance policy from a third party, or conservative financial policy of the hosting service provider with or without a mandatory financial reserve, or other means. The information contained in an internet site can be in the form of text, audio or video signals, or of any other type. The hosting system may provide for migration of the stored information to new, yet to emerge technological platforms, if needed. The stored information may be accessible by wide public or may be made—partially or in its entirety—protected by a password or other security measures limiting access to the information to trusted recipients of the information, such as descendants or other, perhaps yet to be born, people. The system may be built in a purpose-created internet domain. The system may be operated on commercial basis with fees possibly dependent on the size of information stored and possibly collected upfront.

### BACKGROUND

The disclosed invention pertains to the field of conveying information to recipients whereas the author of the information is likely to have passed away at the time of information retrieval. The task necessitates information preservation to ensure its survival as well as information protection to ensure access to the information is granted to authorised recipients only. The prior art for conveying information includes all forms of writing on all sorts of media, paintings on all kinds of media and all sorts of audio and video recordings—both analogue and digital—on all sorts of media. The prior art for information preservation includes writing and drawing on all kinds of lasting media (e.g. cave drawings, stone and clay tablets, etc.) as well as all current technologies for backing up digital information on various kinds of media. The prior art for information access control includes all current technologies for password and biometric protection of information.

### SUMMARY

The disclosed invention provides a single solution to the three problems of information conveying, preservation and protection for retrieval of the information after the author has passed away. The invention applies modem digital age technologies of information preservation and protection as a solution to the much older problem of passing information through ages to the descendants and future generations.

### DESCRIPTION

People need to live behind memories of themselves. That is why they erect expensive burial structures, build pyramids using hard to use but also hard to steal large stones, to ensure that the pyramids survive longer. People commit acts of heroism, conquer mountain peaks, set speed records, establish prizes and scholarships, to ensure their names live in time. People are afraid of death and seek ways—religious or other—to defeat it.

A system of lengthy internet hosting of information allows people to leave memories of themselves and control the contents of these memories. A user of the system can create a small Internet site, information contained in which is guaranteed to be hosted for a lengthy period of time or indefinitely. The user may leave their autobiography complete with pictures, audio and video materials, listing achievements and decorations. The user may leave a message to their descendants. The user may leave their genetic makeup information protected by a passed to the descendants in a will password in the hope, that when the cloning technologies sufficiently develop, the user's descendants may re-create the user. In the future, new types of information worth storing may emerge. For example, if technology for recording human memories and experiences is developed, this information may be worth storing and it may complement the genetic information for potential resurrection of the user.

The internet hosting system can be operated commercially. An upfront fee may guarantee hosting of the client's information for a lengthy period of time or indefinitely. The guarantee of length of hosting services may be based on an insurance policy from a third party, or conservative financial policy of the hosting services provider with or without a mandatory financial reserve, or other means. The fee for services may depend on the size of stored information. The service may entitle the client to migration of the stored information to a new hosting platform should a new technology replace internet.

The system allows the client to purchase required volume of information to be stored on a specific, purpose domain name internet site and upload, for example by means of the file transfer protocol (ftp), their information. The system allows for some of the pages on the site be protected by a password which can be revealed to a trusted person or persons, for example to the descendants in a legal will. The system allows for the upload of information to the purchased site be protected by a password known only to the client and the password is meant not to be revealed to anyone so that the ability to change information on the purchased site is lost with the eventual death of the client. The system allows for the access to the information stored on the site by means of direct address (for example, http://www.eternaldatabank.com/1234567) or search based on the client's name and/or keywords. The service may be offered to anyone irrespectively of their place of residence or citizenship.

1. A system of providing hosting of data and/or websites containing text, audio, video or other kinds of information for lengthy or indefinite periods, thus the content surviving its creator, while the system may have an attached guarantee of providing hosting services for a given lengthy or indefinite period and while the stored information—partially or in its entirety—may be protected by a password or other security measures limiting access to the information to certain groups and/or individuals.

2. An internet/web/cloud/online hosting system as claimed in claim 1, wherein the guarantee of length of hosting services is based on an insurance policy from a third party, or conservative financial policy of the hosting services provider with or without a mandatory financial reserve, or other means.

3. An internet/web/cloud/online hosting system according to any claims 1 and 2 wherein the information can be stored on a site in a purpose-created internet domain, the fee for internet/web/cloud/online hosting services may be collected upfront and may be based on the size of information stored, the fee paid may entitle the client to migration of the stored information to newly emerging technologies.
